(19) United States
(12) Patent Application Publication
(10) Pub. No.: US 2003/0159593 A1
(43) Pub. Date: Aug. 28, 2003

(54) Method and device for preparing pre-cooked meals

(76) Inventor: Robert Leutwyler, Boppelsen (CH)

Correspondence Address: Oliff & Berridge, PO Box 19928, Alexandria, VA, 22320, US

(21) Appl. No.: 10/362,985

(22) PCT Filed: Aug. 27, 2001
(86) PCT No.: PCT/CH01/00520

(30) Foreign Application Priority Data
Aug. 31, 2000 (CH) 1703/00

(51) Int. Cl. A23L 1/00

(52) U.S. Cl. 99/348

(57) ABSTRACT

The invention relates to a method and a device for preparing pre-cooked meals which are supplied in a first and a second, separate component, especially pre-cooked pasta and pre-prepared sauce. Even heating is ensured by exposing at least the first component to hot steam in a closed mixing container for a set period of time, stirring and/or shaking at the same time, before or after the second component has been added. The method can be carried out fully automatically so that the finished meal only comes into contact with the person just before serving. 100 to 200 meals can be prepared per hour with the inventive device. The invention is therefore particularly suitable for preparing meals in the fast food sector.

The invention relates to a method and a device for preparing pre-prepared meals as claimed in claim 1 and 11, respectively.

In the fast food sector, there is the problem of supplying meals rapidly and with consistently good quality at an acceptable price. Meals which have been pre-prepared in portions and stored in cooled or frozen form are heated in reserve or in accordance with the customers order. Microwave ovens are regularly used for defrosting and heating pre-cooked meals. However, the meals are frequently not heated up uniformly in said microwave ovens; rather, they remain cold on the inside and are overheated on the outside. Furthermore, the quality of the meals also suffers from the nonuniform heat load. Heating in a double boiler is time- and labor-consuming. For pasta products, in particular, a satisfactory solution, in which the pasta neither dries out, sticks together nor becomes too soft, is not known.

The invention is therefore based on the object of supplying a method and a device for preparing pre-prepared meals, with which the abovementioned disadvantages of the prior art are avoided, and meals of a consistently high quality can be prepared rapidly, hygienically and cost-effectively.

The object is achieved by a method and a device for preparing pre-prepared meals having the features of claim 1 and 11, respectively. Advantageous developments of the method and of the device are specified in the dependent claims.

According to the method according to the invention, pre-prepared meals are supplied in a first component and a second component which is separated therefrom.

This ensures, firstly, a greater number of selection or combination options among the finished dishes and a given number of pre-prepared components. An enlarged menu can therefore be provided. The mixing of the two components only just before consumption prevents the meal from becoming soggy and the quality of taste from changing. The method is suitable, in particular, for preparing precooked pasta and pre-prepared sauce, but also pre-prepared rice with a pre-prepared side dish and similar components which are to be mixed together.

According to the invention, uniform heating is ensured by exposing at least the first component, before or after the second component has been added, in a closed is mixing container to hot steam, which is supplied to the mixing container, for a predeterminable period of time, and by stirring and/or shaking it at the same time. The stirring, is carried out by a suitable stirring implement which protrudes into the mixing vessel, for example a stirring hook or a screw. The stirring affords the advantage of effectively thoroughly mixing the components and evening out the heat, but is less suitable for meals composed of relatively long components, for example spaghetti. As an alternative or an addition, the mixing vessel can be shaken, which enables spaghetti and similar products also to be effectively mixed with the second component.

Steam heating affords the advantage that the meal can be heated very rapidly and gently without losses of quality. Heating in the cooking space of the mixing container is very energy-saving, since only a little water has to be evaporated in order to generate the steam. The goodness is thus not washed out of the product being cooked and color, inherent taste, and nutrient and vitamin content are retained. To this end, the steam preferably has a temperature of 100 to 160° C., preferably 140° C., and a water content of 0.5 to 3 ml of water per liter of steam, preferably 1 ml of water per liter of steam. The product being cooked is preferably heated and stirred and/or shaken for a cooking time of 10 to 40 seconds. Good heating and mixing are already obtained at a cooking time of preferably approximately 15 seconds. If appropriate, after heating, the components can be stirred or shaken even more for further evening out of the heat and better thorough mixing.

The two components are brought together before the heating and mixing it the two are to be heated together, for example in the case of pasta with a hot, sauce. If the second component is not heated, for example in the case of pesto sauce or carbonara, it is is added after the heating and thorough mixing of the first component and is preferably mixed once more without heating.

Exemplary embodiments of the invention are illustrated in the drawing and are described below. In the drawing, purely schematically:

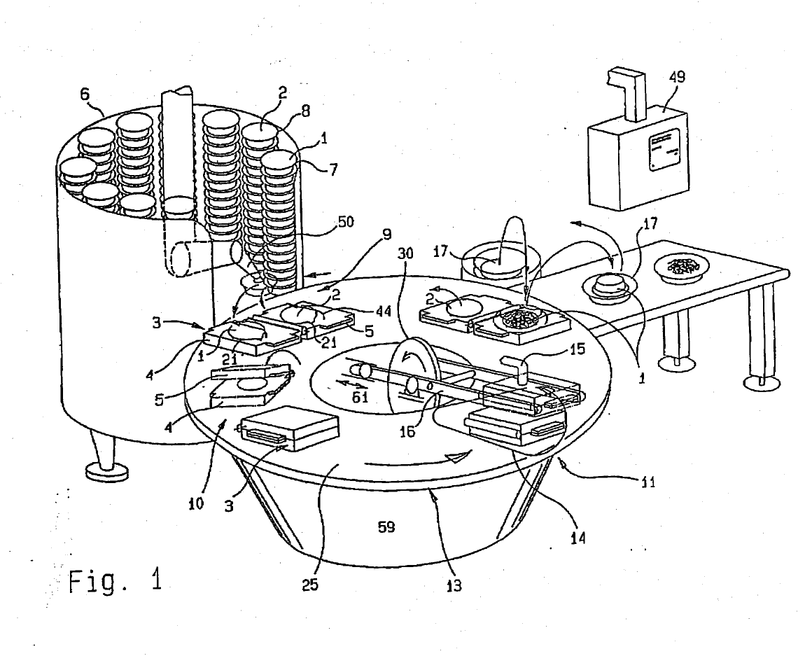

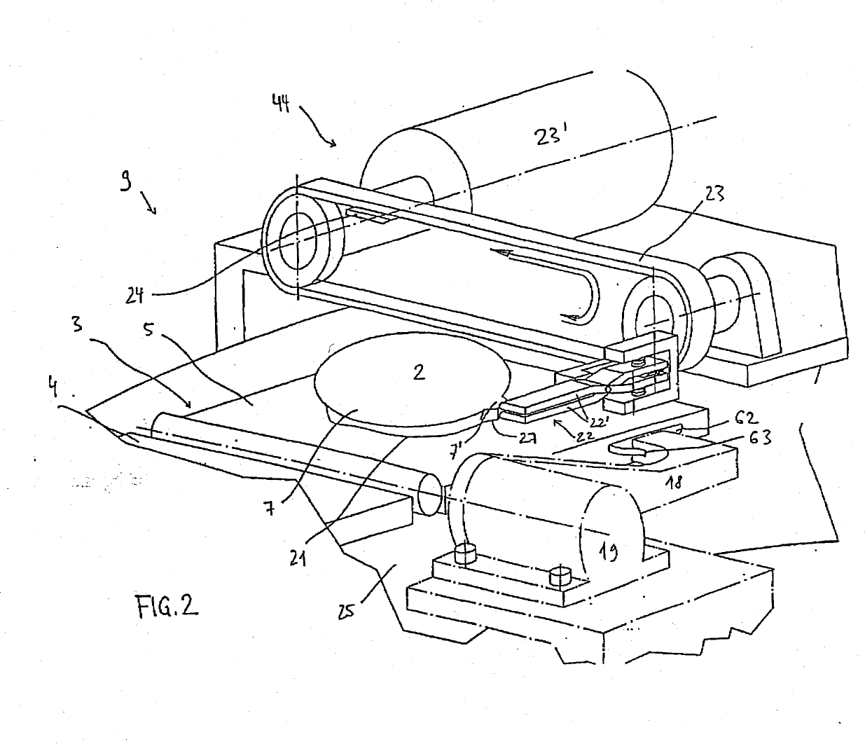

FIG. 1 shows a device according to the invention with a rotating transportation table;

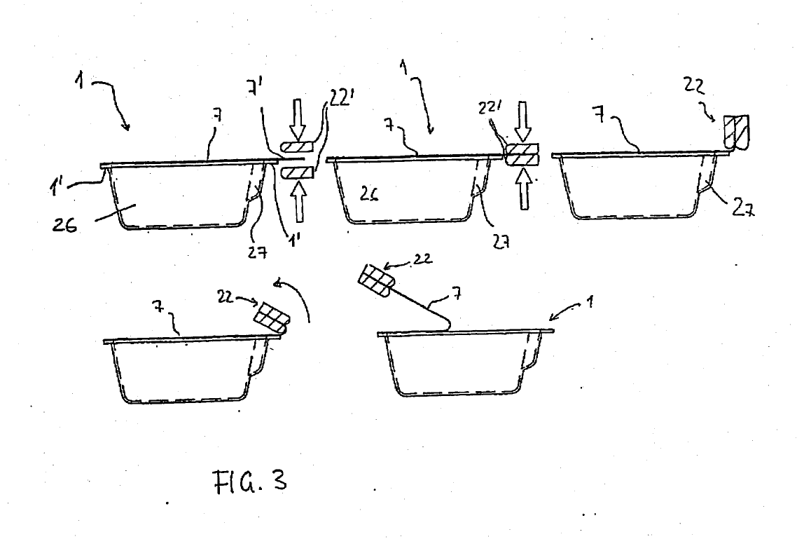

FIG. 2 shows an opening device for opening subcontainers sealed with sheet;

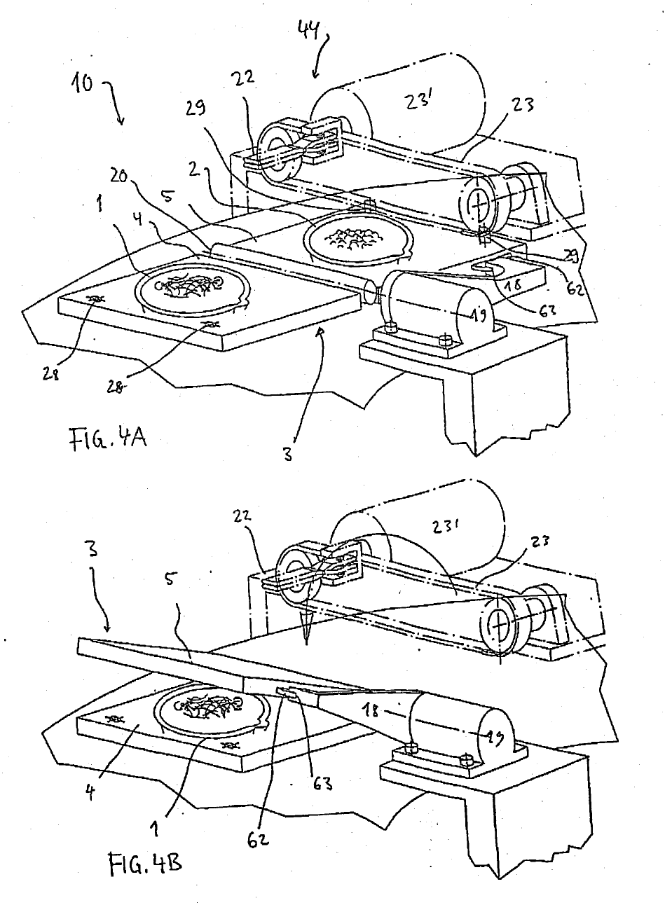

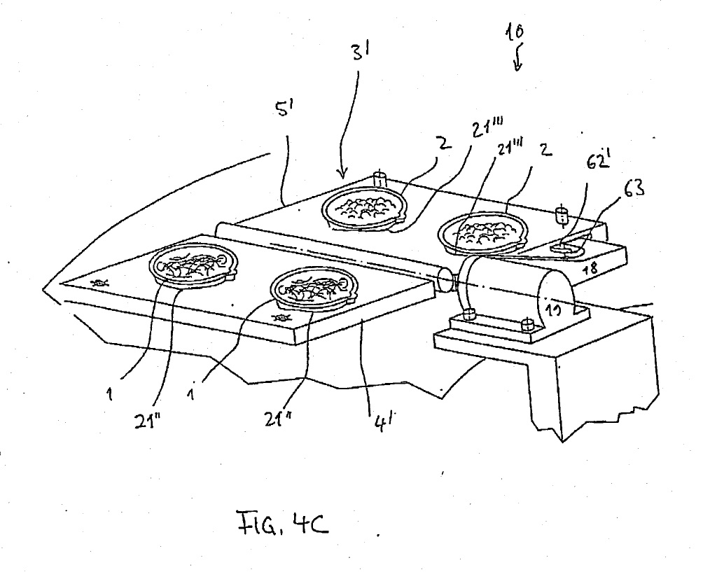

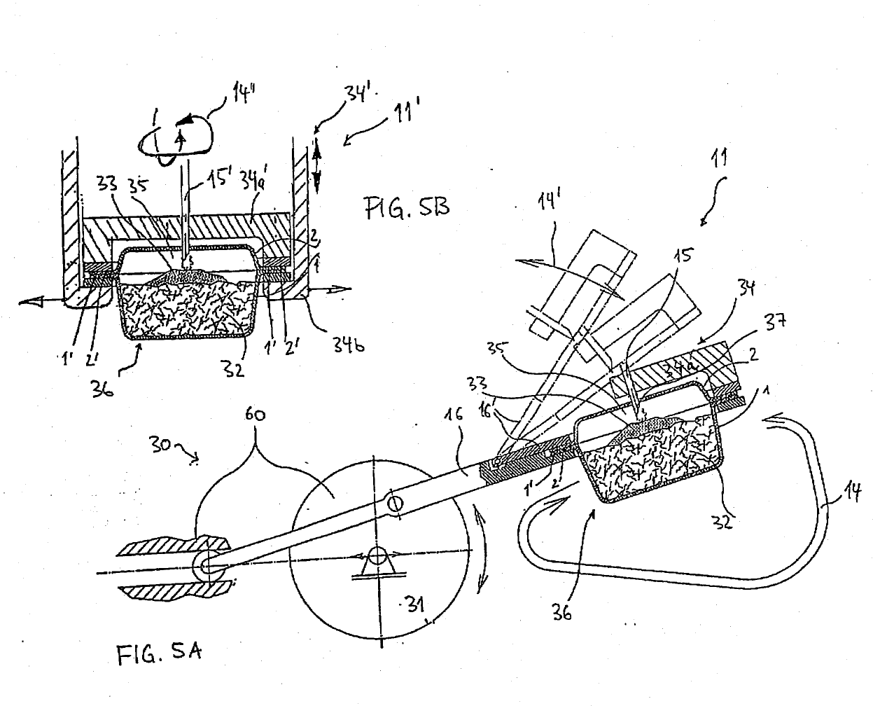

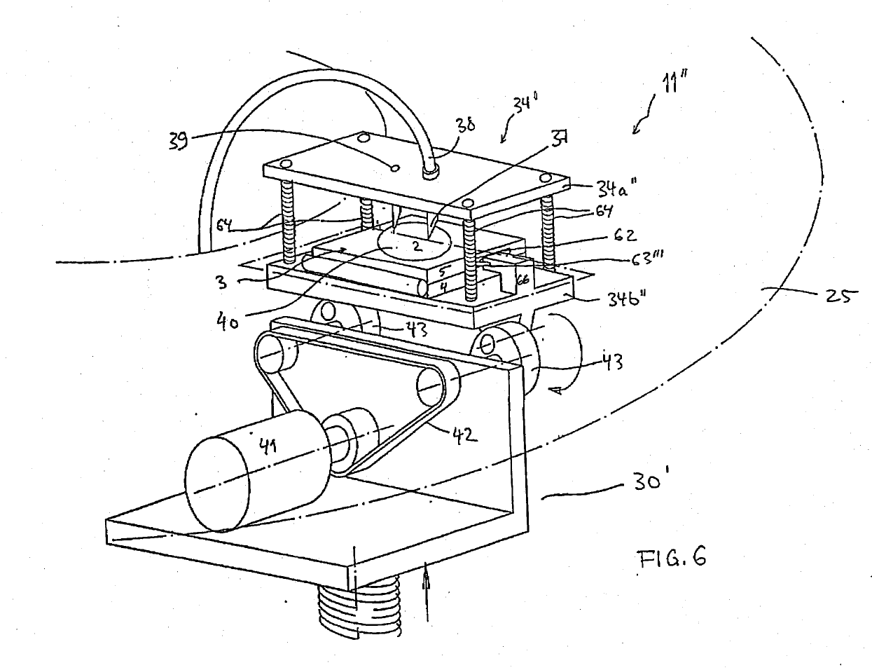

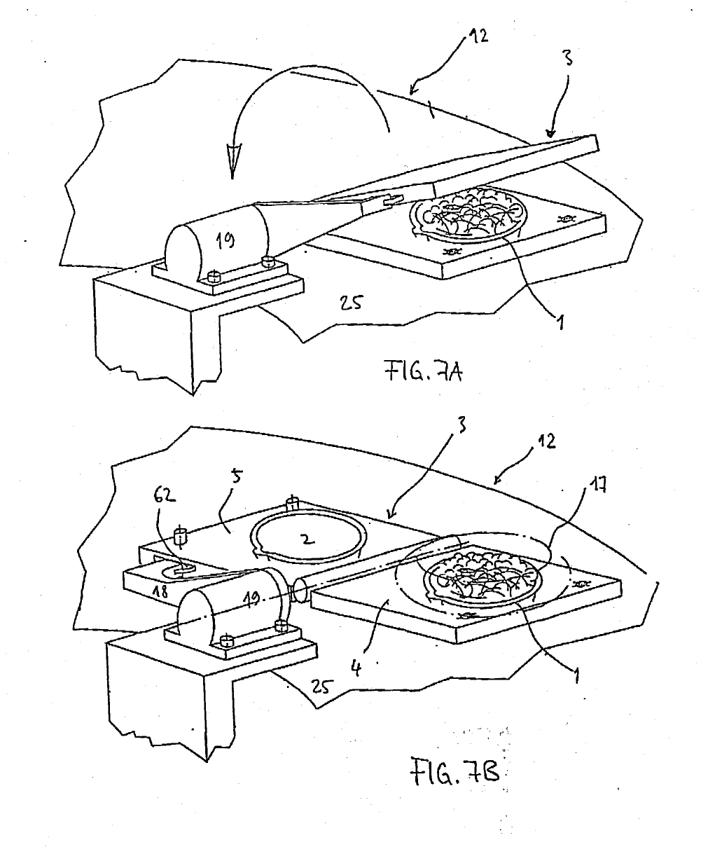

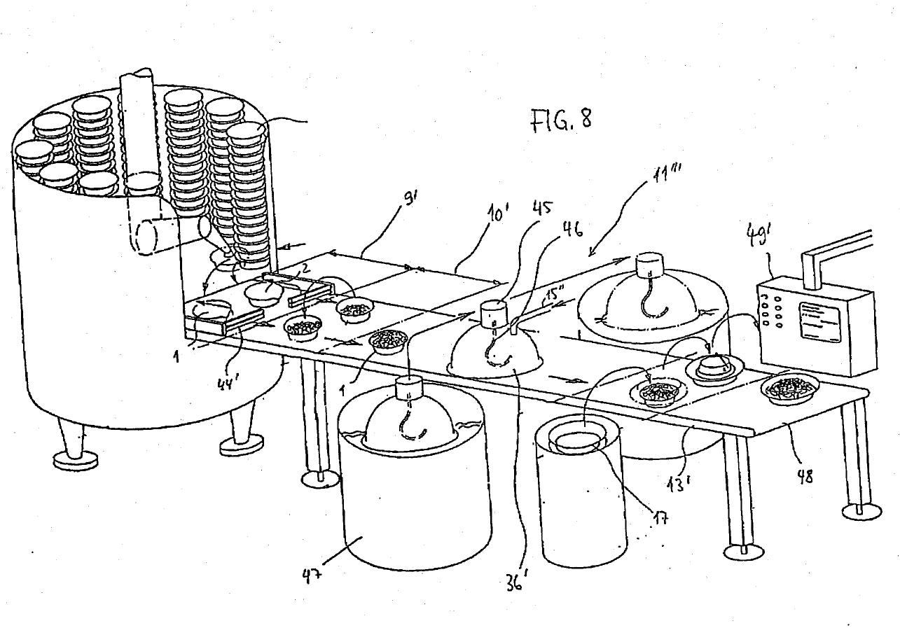

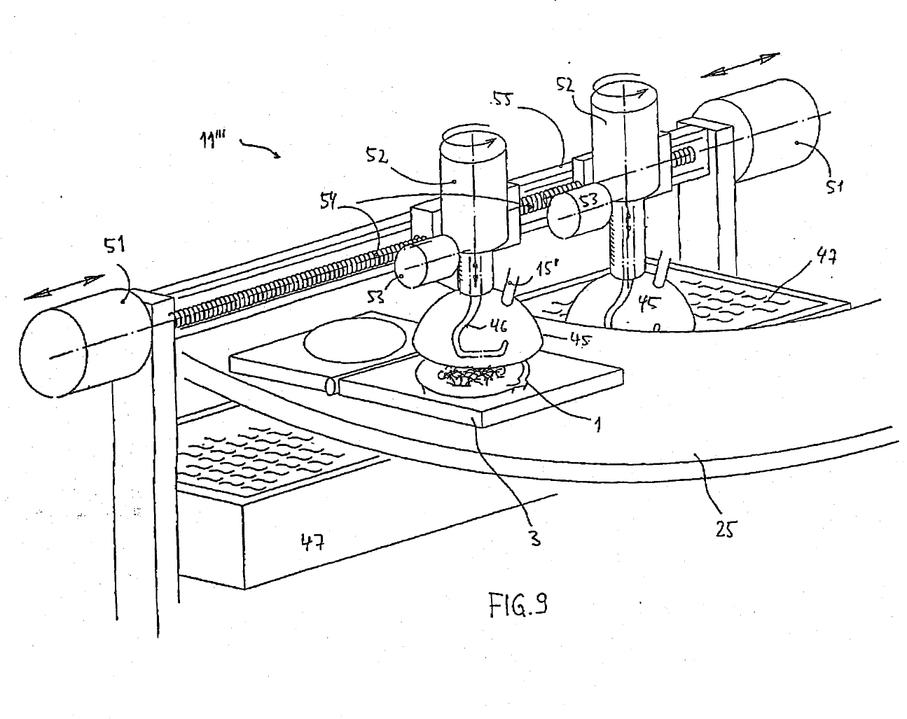

FIG. 3 shows the opening process of a subcontainer;

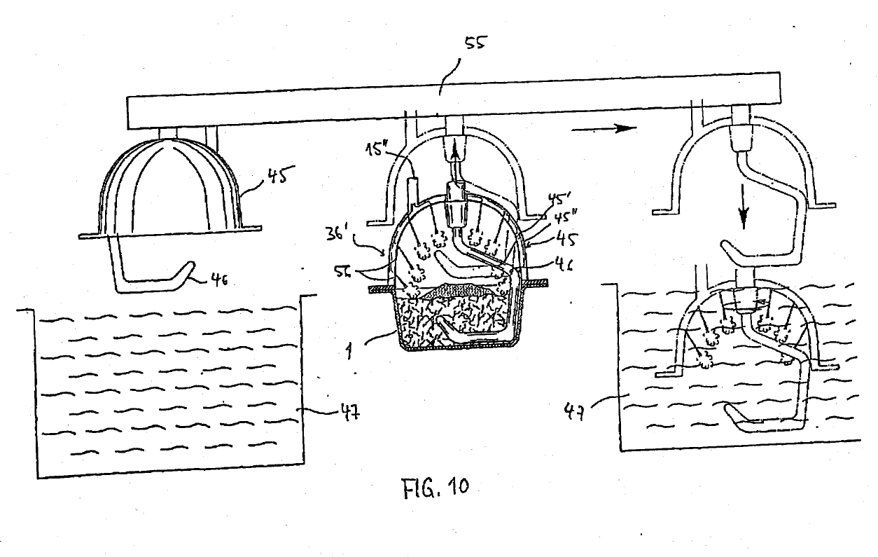

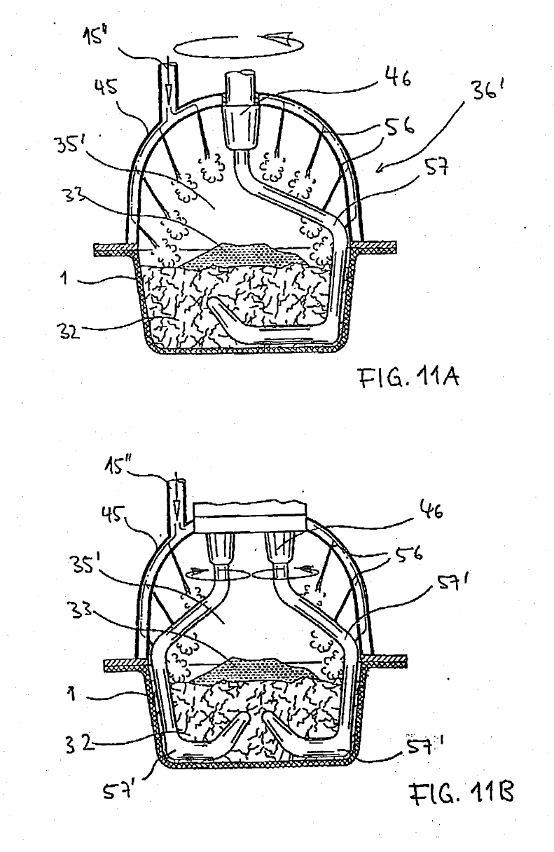

FIGS. 4a, b show the overturning of a first subcontainer onto a second subcontainer in an overturning station;.

FIG. 4c shows an overturning device with a carrier for two first and second subcontainers in each case;

FIG. 5a shows a first example of a mixing and heating station

FIG. 5b shows a second example of a mixing and heating station;

FIG. 6 shows a third example of a mixing and heating station;

FIGS. 7a, b show the opening of the carrier in an unloading station;

FIG. 8 shows a schematic diagram of a further. device according to the invention with a conveyor belt as transportation device;

FIG. 9 shows a further mixing and heating station with steam covers and a stirring device;

FIG. 10 shows the mixing and heating station from FIG. 9 in side view;

FIGS. 11a, b show a mixing container with a steam cover and one or two mixing hooks in longitudinal section;

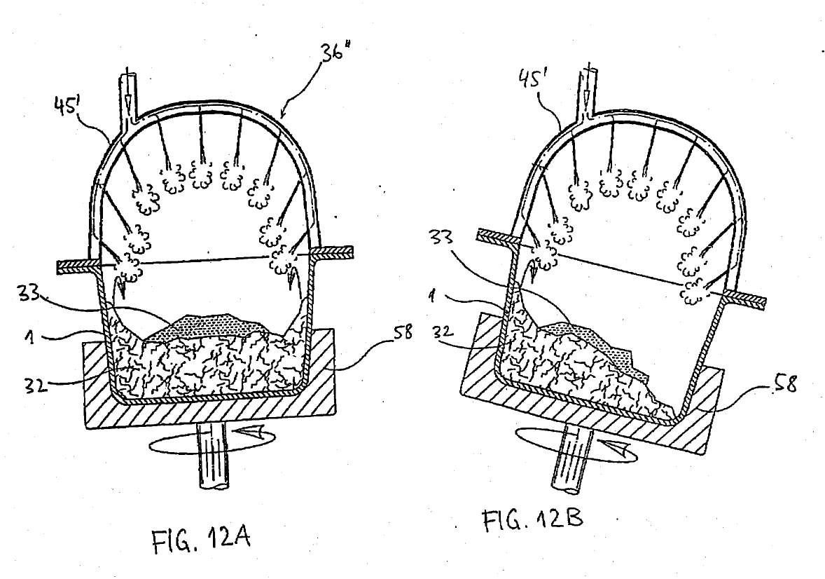

FIGS. 12a, b show a mixing container with a steam cover, said container having been placed onto a rotating mixer.

In FIG. 1, a device according to the invention for preparing pre-prepared meals is illustrated schematically. First and second components of the meals are situated pre-prepared, portioned, packed and cooled in the first and second subcontainers 1 and 2, respectively. In each case one component, together with a second component, results in a finished dish. The first and second subcontainers 1, 2 are mounted in stacks in a magazine 6 which also acts as a cooling device. A robot 50, which is activated via a control device 49, grasps a first and a second subcontainer 1 and 2, respectively, in accordance with a customer's order. In a loading station, the subcontainers 1, 2 are inserted in a precisely fitting manner into corresponding receiving openings 21, 21′ of carrier parts 4, 5 of a carrier 3 and are secured. The carrier 3 is situated on a transportation device 13, here in the form of a rotating table 25, in the region of the loading station 9. Furthermore, in the loading station 9, the covering sheets 7, 8 of the first and second subcontainer, respectively, are removed by means of an opening device 44, which is illustrated more precisely in FIG. 2. As an alternative, a dedicated station to which the carrier 3 is conveyed is provided for opening purposes.

After the carrier 3 has been loaded with subcontainer 1, 2, the transportation table 25 is rotated, as a result of which the carrier 3 reaches an overturning station. The second carrier part 5, which contains the second subcontainer 2, is overturned here onto the first carrier part 4 in order to form a closed mixing container. The overturning may also take place during the rotational movement. The overturning causes the first and second subcontainers 1 and 2 to come to lie with their approximately identically sized openings on each other. The second component is thereby tipped onto the first component, for example sauce onto pasta. The two carrier parts 4, 5, and therefore the two subcontainers 1, 2, are held such that they are pressed preferably in a joined manner onto each other, with the result that the mixing container is closed. The closed carrier 3 is then supplied, by rotation of the transportation table 25, to a mixing and heating station 11 where it is grasped and moved-, by means of a crank mechanism 60 having a connecting rod 16, along a circular path 14 in a plane situated perpendicularly with respect to the plane of the transportation table.

The crank mechanism 60 is arranged in a cutout 61 in the table center. Steam for heating the meal is supplied to the mixing container via a supply device 15 during the shaking procedure. The mixing container is subsequently deposited again on the transportation table 25.

By further rotation of the transportation table 25, the carrier 3 is supplied to an unloading station 12 where the carrier parts 4, 5 are swung apart again and the emptied second subcontainer 2 is disposed of. A plate 17, which has been pre-heated if possible, is inverted onto the first subcontainer 1, which contains the heated and mixed components of the meal. The first subcontainer 1 and the plate 17 are then rotated together through 180° about a horizontal axis and the subcontainer 1 is disposed of. The finished dish can now be served directly on the plate 17.

Since all of the described steps proceed automatically, the ready-heated dish can come into contact with the person only when being served while the preparation takes place under precisely controllable hygienic conditions. In the pauses in operation, the entire device is cleaned, for example by a cleaning cover being inverted onto the transportation table together with the individual stages, and the entire device being sprayed with known detergents and water jets. The waste water can be collected in a collecting trough 59 arranged below the transportation table 25.

With heating and mixing times of approximately 15 seconds an ordered dish can be delivered approximately 3 minutes after being ordered. Approximately 100 dishes per hour can be heated with the device illustrated in FIG. 1. A further increase in output can be achieved if use is made of carriers which can in each case receive two first and two second subcontainers, see FIG. 4c.

If only the first, but not the second component of a dish is to be heated, first of all in the loading station 9 the first subcontainer 1 is inserted into the corresponding cutout 21′ of the carrier 3. An empty, s open subcontainer is inserted into the opposite cutout 21, said subcontainer likewise coming from the magazine 6 and, together with the first subcontainer, forming the mixing container. By passage through the overturning station 10 and the mixing and heating station 11, the first component is heated and, by further rotation of the transportation table 25, is returned to the loading station 9. The empty, second subcontainer, which is used for mixing purposes and has been removed in the meantime, is replaced by a second subcontainer which contains the second component. Said second subcontainer is opened, and subsequently the overturning station 10 and the mixing and heating station 11 are passed through again. This time only mixing takes place in the mixing and heating station 11, but steam is only supplied to a reduced extent, if at all. The second component is thus not exposed to a high heat load. As in the already-described case, the finished dish is overturned onto a plate and delivered.

FIG. 2 shows a detailed view of the loading station 9. The second subcontainer 2, which is still closed by sheet 7, is already situated in the cutout 21 of a carrier part 5 of the carrier 3. For the defined alignment relative to the carrier part 5, each subcontainer has an extension 27 or, in general, such a container shape that it can only be inserted into the correspondingly shaped cutout 21 in the carrier part [lacuna] a defined position in a precisely fitting manner. This orientation here is undertaken in such a manner that a protruding end 7′ of the covering sheet 7 can be grasped by clamping jaws 22′ of a pair of tongs 22. The pair of tongs 22, as part of the opening device 44, is moved along an oval path of movement via a driving belt 23 and a motor 23′. In the process, the end 7′ of the covering sheet 7 is first of all pulled upward and then pulled to the rear, which is illustrated in FIG. 3. By means of a slotted guide 24, which is arranged along the belt 23, the pair of tongs 22 is opened and the grasped covering sheet 7 released, whereupon it falls into a supplied waste bin (not illustrated here). A further opening device for opening the first subcontainer, which is situated in the carrier part 4, is provided (not illustrated here), mirror symmetrically with respect to the opening device 44. The second carrier part 5 can be folded onto the first carrier part 4 by means of a motor 19, to which it is connected via a lever 18. For this purpose, the carrier 3, or at least the second carrier part 5, has a tongue 62 which is integrally formed laterally in the transportation direction and can be introduced in a form-fitting manner into a slot 63 in the lever 18 by rotation of the transportation table 25 or, in general, by conveying the carrier 3 further.

FIG. 3 shows, schematically, the design of a subcontainer 1 and the sequence of the opening procedure. The subcontainer 1 comprises a dish with a laterally protruding edge 1′. At the side, it has an extension 27 for inserting it in a precisely fitting manner into a correspondingly shaped cutout of the carrier. A component of the reel to be supplied is situated in the interior 26 of the subcontainer 1. The subcontainer 1 is covered by a flat film 7 which is bonded or welded on the edge 1′ and protrudes laterally at one end 7′. For opening purposes, this end 7′ is grasped by two clamping jaws 22′ of a pair of tongs 22, is pulled upward and then to the rear, as a result of which the sheet 7 is pulled off.

FIGS. 4a and 4b show, schematically, the overturning process in the overturning station 10. The first and second subcontainers 1 and 2, which have already been opened, containing the corresponding meal components are situated on the carrier 3. The opening device 44 used for opening purposes is illustrated by dash-dotted lines. The motor 19 is then used to pivot the lever 18 and the second carrier part 5, which is connected to said lever in a form-fitting manner via the tongue 62 and slot 63, from the horizontal position and rotated through 180°. For this purpose, the two carrier parts 4, 5 are-connected to a hinge 20. In order to place the carrier parts 4, 5 on each-other in a precisely fitting manner, the first carrier part 4 has centering holes 28 and the second carrier part 5 has corresponding pins 29. This ensures that the opened first and second subcontainer 1 and 2 come to lie on each other forming a closed mixing container. The pivoting movement of the lever 18 and of the carrier part 5 has to be sufficiently rapid to ensure that the second component does not run out. The first carrier part 4 is preferably also raised somewhat, in order to shorten the folding-together process.

FIG. 4c shows an overturning device 10 with a carrier 3′ having a first and second carrier part 4′ and 5′, respectively, each carrier part having two cutouts 21″, 21′″ for first and second subcontainer 1, 2, respectively. At least the second carrier part 5′ also has a tongue 62 here which can be introduced into the slot 63 of the lever 18.

FIG. 5a shows a first example of a mixing and heating device 11 with a pivoting and shaking device 30 in the form of a trunk mechanism 60 having a connecting rod 16 and an eccentric 31. That end of the connecting rod 16 which faces away from the trunk mechanism 60 moves along a circular path 14 in the form of a triangle with rounded corners. A corresponding guide may also be provided in order to force the mixing vessel 36 onto this circular path. The mixing vessel 36, which is formed by the first and second subvessels 1 and 2, is fastened to this end of the connecting rod 16. The movement of the connecting rod 16 causes the first component 32, which is contained in the mixing vessel 36, to be mixed with the second component 33. The two subvessels 1, 2 are clamped between the connecting rod 16 and a pivoting arm 16′ fastened thereto. If the subvessels are situated in a carrier, the carrier parts or, preferably, the tongues fastened laterally thereto, are clamped between the connecting rod 16 and pivoting arm 16′. For loading and unloading the mixing and heating station 11, the pivoting arm 16′ can be pivoted upward, preferably by means of a drive, which is illustrated here by dash-dotted lines. The pivoting arm 16, furthermore carries the supply device 15 for steam. As the pivoting arm 16′ is being pivoted around, a hole is pierced in the bottom of the second subvessel 2, thus in the lid of the mixing vessel 36, by means of a hollow needle 37, which forms the inlet opening for steam. If the subvessels are secured in a carrier, at least the second carrier part has an opening in the base, through which the container base is accessible. The securing of the supply device 15 on the pivoting lever 16′, the supply device and the pivoting lever 16 form a closing and steaming unit 34 the collar with which the mixing vessel can be kept closed and with which steam is supplied for heating the interior of said mixing vessel.

FIG. 5b shows a further mixing and heating station 11′, in which the mixing of the first and second components 32, 33 is achieved by combining movements, which are generated by a linear motor, in the horizontal and vertical direction. Steam is passed into the interior 35 of the mixing container 36 by means of a supply device 15′. The mixing vessel 36 rests with its edge 1′, 2′ on a retain frame 34b. The first and second subcontainers 1, 2 are pressed onto each other by the retaining part 34a′, which also carries the supply device 15′. The mixing vessel 36 therefore remains securely closed during the shaking procedure.

FIG. 6 shows a further mixing and heating station 11″. The folded-together carrier 3 lies on a retaining plate 34b″ which is set into a rotating movement by means of a shaking device 30′. The shaking device 30′ comprises eccentric rollers 43 which are driven by a motor 41, by means of a driving belt 42, and are connected to the retaining plate 34b″. The tongue 62 of the second carrier part 5 is in engagement with a slot 63′″ on an arm 66 which extends upward from the lower retaining plate 34b″, so that the carrier is kept in place and cannot swing open during the shaking procedure. An upper retaining plate 34a″ is supported on a lower retaining plate 34b″, the retaining plates 34a″ and 34b″ being moveable with respect to each other in the vertical direction by means of spindle drives 64 and forming a closing and steaming unit 34″. A flexible tube 38 as the supply unit for steam is guided through the upper retaining plate 34a″. Said flexible tube leads into a hollow needle 37 with which the second subcontainer 2 can be pierced through an opening 14 in the base of the carrier 3 when the retaining plates 34a″, 34b″ are moved relative to each other. A further hollow needle 38, which likewise pierces the subcontainer 2, serves as relief opening 15, in order to prevent excess pressure from being produced in the mixing container. In FIGS. 7a, b, the unloading of the carrier 3 in an unloading station 12 is illustrated schematically. The carrier 3 is swung open by means of the motor 19 and the lever 18, which is in engagement with the tongue 62. The mixed and heated dish is now in the subcontainer 1 in the carrier part 4 and the empty subcontainer 2 is in the other carrier part 5. The subcontainer 1 is now covered by a plate 17 and overturned, preferably by means of a robot, while the subcontainer 2 is directly disposed of.

FIG. 8 shows a further example of a device according to the invention with a conveyor belt 46 as transportation device. As already described, subcontainers 1, 2 are situated in a cooled magazine 6 and are inserted into carriers in a loading station 9′ by means of a robot 50, The carriers are not illustrated in the present case. The covering sheets are removed by means of opening devices 44′. The second subcontainer 2 is overturned onto the first subcontainer 1 in an overturning device 10′. In a mixing and heating station 11′″, a steaming cover 45 is placed onto the subcontainer 1, which now contains both meal components. Said steaming cover contains a connection for a steam-supply means 15″ and, in its interior, at least one inflow opening for steam. A stirring device 46, here in the form of a mixing hook is also arranged in the interior of the steaming cover 45. The mixing hook is rotated during the inflow of steam in order to uniformly and thoroughly mix and heat the product being cooked. The cover 45 is preferably designed in such a manner that it ends flush with the edge of the subvessel 1, and thus forms a closed mixing container 36′. After thorough mixing and heating has taken place, the cover 45 is raised, moved laterally and cleaned in a washing device 47. The latter comprises, for example, a water basin into which the cover 45 is immersed. It is advantageous if, as here, there are two covers 45, one of which is always in operation while the other is being cleaned. The heated and thoroughly mixed dish is transported on by means of the conveyor belt 48, if covered by a plate 17, overturned and placed ready for serving. The entire device is controlled by means of a control device 49′. In this case too, it is possible for the finished dish to come into contact with people only when being served.

FIG. 9 shows a detailed illustration of the mixing and heating device 11′″ from FIG. 8, here with a rotating transportation table 25. The two meal components are situated in the first subvessel 1, which is inserted into the carrier 3. The latter is moved, situated under the steaming bell 45, on the transportation table. By means of a first drive 53, the steaming bell 45 together with the steering device 46, which is integrated in it, is lowered onto the carrier 3 and, together with the subcontainer 1, forms a closed mixing container 1. A second drive 52 is used to set the stirring device 46 into a rotational movement, as a result of which the components are mixed. During the stirring procedure, hot steam is supplied via the supply device 15″. The cover 45 is subsequently raised again by means of the first motor 53 and moved, by means of a third motor 51, in the lateral direction relative to the transportation direction of the transportation table 25. The first drive 53 is used to lower the bell over the washing device 47 for cleaning purposes. A second cover, which is in a cleaning position in FIG. 9, is provided in parallel. Both covers 45 together with the associated first and second drives 52 and 53 are mounted on a guide rail 55. The lateral movement takes place in each case by means of a spindle 54.

FIG. 10 shows the arrangement from FIG. 9 in cross section. The steaming cover 45 is placed onto the subcontainer 1 for heating and mixing purposes, so that a closed mixing container 36′ is formed. The cover 45 itself is double-walled and contains a multiplicity of inlet openings 56 for steam which is passed between the inner and outer wall parts 45′ and 45″, and is supplied by a supply device 15″. The contents of the mixing container 36′ are thoroughly mixed by a stirring device 46 in the form of a mixing hook. After the mixing and heating procedures are finished, the cover 45 is pulled upward and moved laterally along the guide 55 and lowered into a washing device 47. The inflow openings 56 have steam or compressed air blown through them for cleaning purposes. In the meantime, a second cover 45 can be brought again into position for thoroughly mixing and heating a further meal portion.

FIGS 11a and 11b illustrate mixing containers 36′ with a stirring device 46 having one or two mixing hooks 57 or 57′. Steam is passed via a supply device 15″ into the double-walled cover, which ends flush with the first subcontainer 1, said steam passing via inflow openings 56 into the interior 35′ of the mixing container 36′. In the meantime, the mixing hook 57 is set into movement relative to the first subcontainer 1 for thoroughly mixing the first and second component 32, 33. This takes place either by rotation of the mixing hook 57. relative to the cover 45, by rotation of the cover 45 together with the mixing hook 57 with the subcontainer 1 stationary, or by rotation of the first subcontainer 1 with the cover stationary, as illustrated in FIG. 12a. As an alternative to the mixing hook, conical screws or blades can be used as the mixing tool. A stirring mechanism or a planetary mechanism may be used. Suitable materials for the mixing tools are steel, thermoplastic or duroplastic. It is also possible, as shown in FIG. 11b, for a plurality of mixing tools to be used. The shape of the mixing tools may vary specific to the dish. It is also possible, in the case of the covers of the mixing and heating device 11′″ shown in FIGS. 9 and 10, to provide different mixing tools in order to be able to use them, as required, in different dishes.

As an alternative to the inflow openings in the wall of the cover or in addition to them, inflow openings may also be provided in the mixing tool itself (not illustrated here). This has the advantage that the steam is passed directly into the dish.

FIGS. 12a, b show a further variant of a mixing and heating device. The steaming cover 45′ serves here merely for filling the cooking space with hot steam, but does not have a stirring device. The two components 32 and 33 are thoroughly mixed by the first subcontainer 1 being set into rotation by means of a rotating mixture 58. The centrifugal action causes the product being cooked to rise upward at the edges and to slide over the slope which is formed. A mixing action arises merely on the surface. However, advantages are a simple construction, easy cleaning, a mild mixing action and low abrasion. As an alternative, the stationary cover 45′ may be provided with a stationary mixing tool in order to further reinforce the rotation action.

In FIG. 12b, the rotating mixer 58′ is additionally set obliquely, as a result of which the mixing of the components 31, 32 is intensified. In a further advantageous development, the rotating mixer together with the mixing container 36″ is set into a pivoting movement in addition to the rotation.

Subcontainers with meal components of one sort, for example, spaghetti, ravioli, tortellini, tomato sauce, pesto sauce, etc., are in each case stored in a stack at a defined point in the magazine 6. Similarly, empty subvessels are stored at a defined point in the magazine. There are preferably at least 32 different components. In this manner, a dish of any desired combination of first and second components can be put together by remote control of the robot. The customer can be offered a great diversity of dishes without the storage place for them having to be substantially increased.

1. A method for preparing pre-prepared meals which are supplied in a first component and a second component separated therefrom, in particular pre-cooked pasta and pre-prepared sauce, uniform heating being ensured by exposing at least the first component, before or after the second component has been added, in a closed mixing container (36, 36′, 36″) to hot steam, which is supplied to the mixing container (36, 36′, 36″), for a predeterminable period of time, and by stirring and/or shaking it at the same time.

2. The method as claimed in claim 1, characterized in that the steam has a temperature of 100 to 160° C., preferably 140° C., and a water content of 0.5 to 3 ml of water per liter of steam, preferably 1 ml of water per liter of steam.

3. The method as claimed in claim 1 or 2, characterized in that the period of time in which heating and stirring and/or shaking is carried out is 10 to 40 seconds, preferably approximately 15 seconds.

4. The method as claimed in one of the preceding claims, characterized in that the steam is supplied at a pressure of 0 to 0.4 bar, preferably 0.2 bar.

5. The method as claimed in one of the preceding claims, in which, in a first step, only the first component is heated by the supply of steam and is stirred and/or shaken at the same time, and, in a second step, the second component is added and both components are stirred and/or shaken together in order to mix them.

6. The method as claimed in one of the preceding claims, in which the first and the second component is in each case situated in a first and second subcontainer (1 and 2, respectively) and one of the subcontainers (1, 2) is overturned onto the other subcontainer (1, 2) for the purpose of joining the two components together, with the result that the first or second component is emptied into the second or first subvessel (2 or 1).

7. The method as claimed in claim 6, it being possible for the subcontainers (1, 2) to be put together in a precisely fitting manner to form a closed mixing container (36), the mixing container (36) being pierced by at least one hollow inlet needle (37) for. the purpose of supplying hot steam, and, for the purpose of thoroughly mixing the two components, being set into a shaking movement, preferably being moved along a path of movement (14, 14′, 14″) not exclusively running in the horizontal direction.

8. The method as claimed in claim 6, a cover (45) being placed onto the first subcontainer (1) before or after the second component has been added, which cover contains a supply duct (15″) and inwardly open inlet openings (56) for steam and, together with the first subcontainer, forms a closed mixing container (36′, 36″), and the mixing container (36′, 36″) being moved for the purpose of thoroughly mixing the two components, preferably being set into a shaking movement, preferably along a path of movement not exclusively running in the horizontal direction.

9. The method as claimed in claim 6, a cover (45) being placed onto the said first subcontainer (1) before or after the second component has been added, the cover, together with the first subcontainer (1), forming a closed mixing container (36′, 36″) and containing a supply duct (15″) and inwardly open inlet openings (56) for steam, and a stirring device, which protrudes into the first subcontainer (1), for stirring the contents during the supply of steam.

10. The method as claimed in one of the preceding claims, in which the mixing container (36, 36′, 36″) is opened after the heating and thorough mixing, a plate (17), the diameter of which is larger than the diameter of the mixing vessel (36, 36′, 36″), is placed onto the opened mixing vessel (36, 36′, 36″), and the mixing vessel (36, 36′, 36″) is turned over together with the plate (17) and is then removed.

11. A device for preparing pre-prepared meals which are situated in a closed mixing container (36, 36′, 36″), having a mixing and heating station (11, 11′, 11″, 11′″), which contains a supply device (15, 15′, 15″), which can be placed at least partially into the interior (35, 35′) of the mixing container (36, 36′, 36″), for steam, and a shaking device (30, 30′), which is capable of setting the mixing container into a shaking movement, and/or a stirring device (46) which can be placed into the interior (35, 35′) of the mixing container (36, 36′, 36″).

12. The device as claimed in claim 11, characterized in that the mixing and heating station (11′″) has a cover (45) which is placed onto a first subcontainer (1), in which the pre-prepared meal is situated, forming the closed mixing vessel (36′, 36″), with a supply device (15) for steam with at least one supply duct, inwardly open inlet openings (56) and a connection accessible from the outside being integrated in the cover.

13. The device as claimed in claim 11, characterized in that the cover has a stirring device (46) protruding into the interior (35′) of the mixing container (36′, 36″)

14. The device as claimed in claim 11, characterized in that the supply device (15, 15′, 15″) for steam has at least one hollow needle (37) which is capable of piercing a wall of the mixing vessel (36).

15. The device for preparing pre-prepared meals which, in a first component and a second component separated therefrom, are present in a first and second subcontainer, in particular pre-cooked pasta and pre-prepared sauce, as claimed in one of claims 11 to 14, characterized by at least one carrier (3) having two carrier parts (4, 5) which can be folded together and are provided with recesses (21, 21′) for holding a subcontainer (1, 2) in a precisely fitting manner, by a loading station (9, 9′) for the insertion of at least one first subcontainer (1) into the carrier (3), an overturning device (10, 10′) for folding the carrier parts (4, 5) onto each other, and a transporting device (13, 13′) for transporting the carrier (3) to the mixing and heating station (11, 11′, 11″, 11′″) and onto a discharge station.

16. Use of a device as claimed in one of claims 11 to 15 for carrying out the method as claimed in one of claims 1 to 10.
